(19) United States
(12) Patent Application Publication
(10) Pub. No.: US 2005/0159143 A1
(43) Pub. Date: Jul. 21, 2005

(54) Mobile communication terminal and automatic answering method thereof

(75) Inventor: Hoe-Won Kim, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 11/005,403

(22) Filed: Dec. 6, 2004

(30) Foreign Application Priority Data
Jan. 16, 2004 (KR) 3374/2004

(51) Int. Cl. H04B 1/40

(52) U.S. Cl. 455/414.4; 455/414.1

(57) ABSTRACT

Disclosed is a mobile communication terminal of a mobile communication system using a plurality of different codecs and an automatic answering method thereof which can perform an automatic answering function with a single type of an automatic answering message without the necessity of storing automatic answering messages of different types that match the respective codecs, and can store automatic answering messages in an encoding form having a small amount of data. The automatic answering method includes performing a call set-up when a call signal is received through an antenna, determining if the automatic answering function is set, reading a pre-stored automatic answering message if the automatic answering function is set, selecting an encoder of a codec which corresponds to a coding type of the call signal received through the antenna during the call set-up, and encoding the read automatic answering message through the encoder.

### PRIORITY

This application claims priority to an application entitled “Mobile Communication Terminal And Automatic Answering Method Thereof” filed in the Korean Industrial Property Office on Jan. 16, 2004 and assigned Ser. No. 2004-3374, the contents of which are incorporated herein by reference.

### BACKGROUND OF THE INVENTION

1. Field of the Invention

The present invention relates to a method for automatically answering a mobile communication terminal, and more particularly to a mobile communication terminal having a plurality of different codecs of and an automatic answering method thereof.

2. Description of the Related Art

GSM (Global System for Mobile communication) is a digital mobile telephone system widely used in Europe and other territories. The GSM digitalizes and compresses data, and then transmits the compressed data along with two streams of other user data through one channel. The respective data are transmitted in their own time zones.

An automatic answering function is a process that automatically reproduces and transmits a message indicating that it is impossible for a user of a telephone to receive a call from a caller, and stores a message transmitted from the caller. This automatic answering function has already been adopted and is used in mobile communication terminals.

The initial GSM-type automatic answering function of a mobile communication terminal will now be explained. Referring to FIG. 7, if a call is received, the mobile communication terminal performs an automatic answering function, and reads an automatic answering message, which has been encoded by an encoder 133 and stored in a storage unit. Then, the mobile communication terminal performs a channel coding of the read message through a channel coder 134, modulates the channel-coded message through a modulator 135, and then transmits the modulated message through an RF unit (not shown) in order to automatically respond to the input call signal.

In the case of recording the message transmitted from the caller, as shown in FIG. 8, the mobile communication terminal decodes the message, which is received through an RF unit (not shown), through a demodulator 142 and a channel decoder 141, and then stores the message in a form of PCM (Pulse Code Modulation) data in a storage unit 110. The initial GSM-type mobile communication terminal is typically provided with a single codec that performs an encoding/decoding operation.

However, in order to heighten the transmission efficiency in the GSM-type mobile communication terminal, diverse types of codecs have been developed and adopted in the terminals, which may be arranged in the order of their development: FS (Full-rate Speech), HS (Half-rate Speech), EFS (Enhanced Full-rate Speech), AFS (Adaptive-multi-rate FS) and AHS (Adaptive-multi-rate HS). The FS type codec completely compresses speech, the HS type codec enables multiple users to use it although the quality of speech is deteriorated, and the EFS type codec is an improved type of the FS type codec. The AFS type codec and the AHS type codec are designed to dynamically vary their compression ratios according to channel environments.

As described above, in the case of a GSM type mobile, communication terminal having a plurality of codecs, a network selects a certain codec by taking into consideration a channel use state, and transmits a codec selection command to the mobile communication terminal. In response to this, the mobile communication terminal processes a call signal by performing an encoding/decoding operation using the corresponding codec in accordance with the codec selection command transmitted from the network.

It is to be noted that the GSM-type mobile communication terminals currently in use are not provided with all of the codecs listed above. For example, some mobile communication terminals may be provided with the codecs of the FS and HS types, which correspond to the initial formats, and coexist with mobile communication terminals provided with codecs of the EFS, AFS and AHS types in addition to the codecs of the FS and HS types.

A switching system, which forms a network to provide call services to mobile communication terminals, may be provided with the codecs of the FS and HS types, which correspond to the initial formats, or may be provided with the codecs of the EFS, AFS and AHS types in addition to the codecs of the FS and HS types, in accordance with the standard of the communication technologies of respective countries.

GSM type mobile communication terminals use diverse types of codecs, and they must encode and store automatic answering messages of different types to match the codecs of different types provided in the network in order to perform the automatic answering function in response to call signals transmitted from the network since it is not known with which type of codec the call signals have been encoded. Accordingly, in the event that a mobile communication terminal that is provided with a plurality of codecs performs the automatic answering function, the mobile communication terminal must repeatedly store an automatic answering message with the same contents for each codec, and this requires a large amount of memory space.

The conventional GSM type mobile communication terminal records the message from the other side's mobile communication terminal as is, without taking into consideration the size of the encoded input call signal, and this may cause the memory to become full and thus unusable.

### SUMMARY OF THE INVENTION

Accordingly, the present invention has been made to solve the above-mentioned problems occurring in the prior art, and an object of the present invention is to provide a mobile communication terminal of a mobile communication system using a plurality of different codecs and an automatic answering method thereof which can perform an automatic answering function with a single type of an automatic answering message without the necessity of storing automatic answering messages of different types that match the respective codecs.

Another object of the present invention is to provide a mobile communication terminal and an automatic answering method thereof which can store automatic answering messages in an encoded form having a small amount of data.

In order to accomplish these objects, there is provided a method for automatically answering a mobile communication terminal which has an automatic answering function and is provided with a plurality of different audio codecs, which comprises the steps of performing a call set-up when a call signal is received through an antenna, determining if the automatic answering function is set, reading a pre-stored automatic answering message if the automatic answering function is set, selecting an encoder of a codec which corresponds to a coding type of the call signal received through the antenna during the call set-up, and encoding the read automatic answering message through the encoder.

In accordance with another aspect of the present invention, there is provided a mobile communication terminal which has an automatic answering function and is provided with a plurality of different audio codecs, which comprises a storage unit for storing an automatic answering message for the automatic answering function, and a control unit for reading the automatic answering message stored in the storage unit, and encoding the read automatic answering message through an audio codec which corresponds to a coding type of a received call.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating the construction of a typical mobile communication system;

FIG. 2 is a block diagram illustrating the construction of a mobile communication terminal in FIG. 1;

FIG. 3 is a diagram illustrating the process of the mobile communication terminal when it transmits an automatic answering message according to the present invention;

FIG. 4 is a diagram illustrating the process of the mobile communication terminal when it records an automatic answering message according to an embodiment of the present invention;

FIG. 5 is a flowchart illustrating the process of the mobile communication terminal when it transmits an automatic answering message according to an embodiment of the present invention;

FIG. 6 is a flowchart illustrating the process of the mobile communication terminal when it records an automatic answering message according to an embodiment of the present invention;

FIG. 7 is a diagram illustrating the process of a conventional mobile communication terminal when it transmits an automatic answering message; and

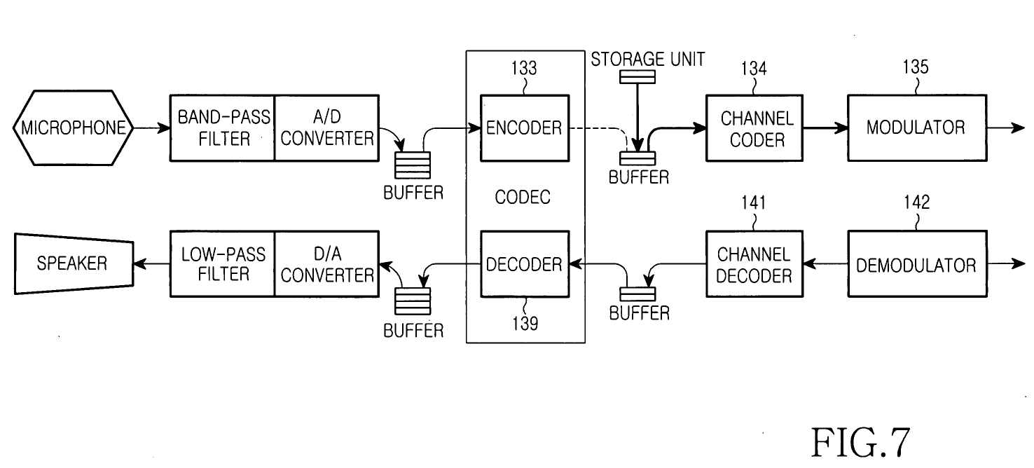

FIG. 8 is a diagram illustrating the process of a conventional mobile communication terminal when it records an automatic answering message.

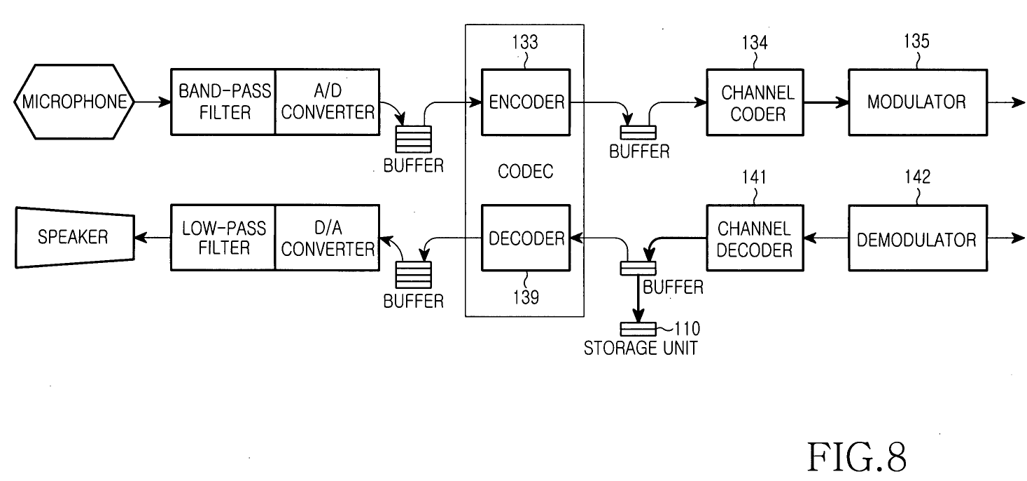

### DETAILED DESCRIPTION OF THE PREFERRED EMBODIMENT

Hereinafter, the mobile communication terminal and the automatic answering method thereof according to preferred embodiments of the present invention will be described with reference to the accompanying drawings. In the following description of the present invention, the same drawing reference numerals are used for the same elements even in different drawings. Also, a detailed description of known functions and configurations incorporated herein will be omitted when it may obscure the subject matter of the present invention.

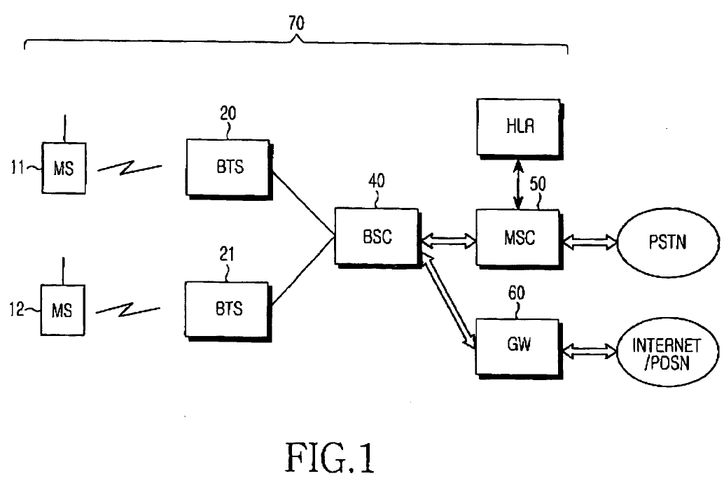

FIG. 1 is a block diagram illustrating the construction of a typical mobile communication system. This mobile communication system 70 supports not only a speech service but also a packet data service to a mobile subscriber.

Referring to FIG. 1, the typical mobile communication system includes mobile communication terminals, i.e., mobile stations (MSs) 11 and 12, base transceiver subsystems (BTSs) 20 and 21, wirelessly connected to the mobile communication terminals 11 and 12, for communicating with the mobile communication terminals 11 and 12, and a base station controller (BSC) 40, connected by wire to the BTSs 20 and 21, for communicating with the BTSs 20 and 21.

The BSC 40 is connected to a mobile switching center (MSC) 50 and also to a gateway (GW) 60. The MSC 50 is connected to a public switching telephone network (PSTN), and the gateway 60 is connected to an Internet/public serving data network (PSDN). Also, shown in home location register (HLR). If the mobile communication terminal 11 connects to PSTN through the MSC 50, a speech service is provided to the mobile communication terminal 11, and if the mobile communication terminal 11 connects to the Internet/PSDN through the gateway 60, a packet data service is provided to the mobile communication terminal 11.

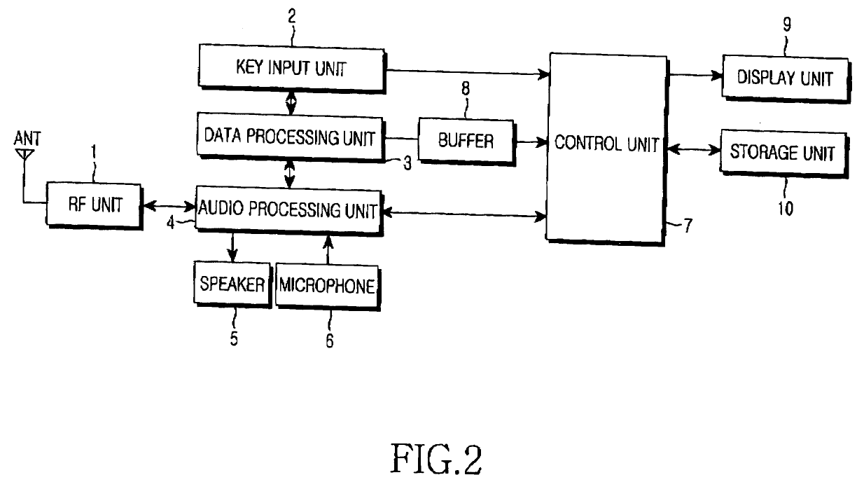

FIG. 2 is a block diagram illustrating the construction of a mobile communication terminal in FIG. 1. Referring to FIG. 2, the mobile communication terminal includes an antenna ANT, an RF unit 1, an audio processing unit 4 for filtering and converting a high-frequency signal received from the RF unit 1 into a digital signal, a data processing unit 3 for compressing and modulating the digital signal output from the audio processing unit 4, a key input unit 2 for receiving a user's key input, a display unit 9 for providing a graphic user interface, a buffer 8 for temporarily storing data, a storage unit 10 for storing various kinds of data, and a control unit 7 for controlling the overall operation of the terminal such as audio and data transmission/reception.

The display unit 9 displays user data output from the control unit 7. Here, the display unit 9 may be implemented by an LCD, and in this case, the display unit 9 may be provided with an LCD controller, a memory for storing video data, an LCD display element, etc. The key input unit 2 is provided with keys for inputting numeric and character information, and function keys for performing various kinds of functions.

The RF unit 1 performs a wireless communication function of the mobile communication terminal 11. The RF unit 1 up-converts and amplifies the frequency of a transmitted signal, and amplifies a received signal and down-converts the frequency of the received signal.

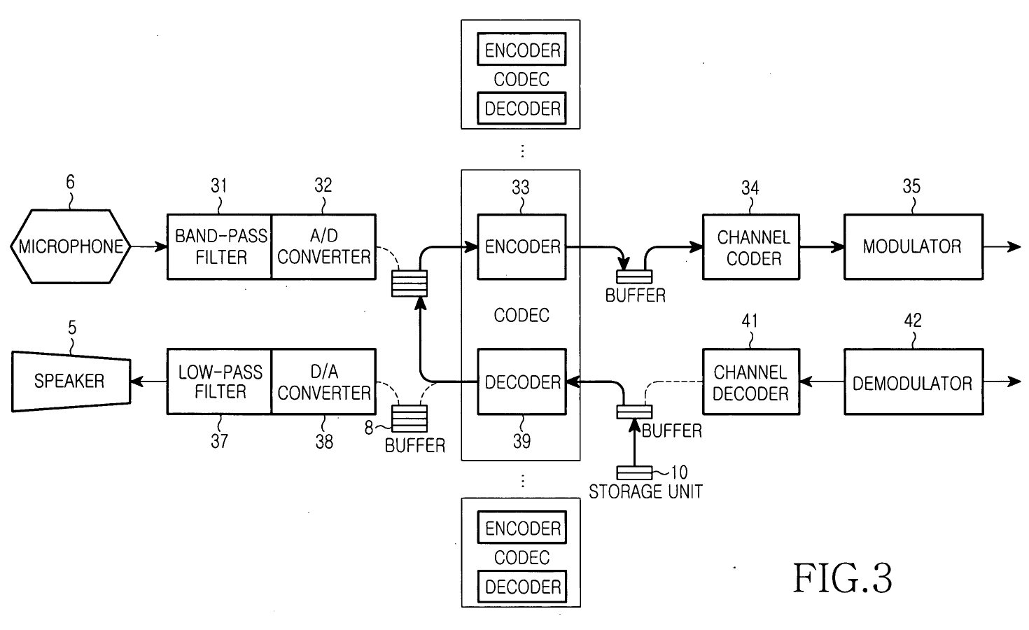

Referring now to FIGS. 2 and 3, the audio processing unit 4 connected to the RF unit 1 reproduces an audio signal received from codecs 33 and 39 of the data processing unit 3, or transmits an audio signal generated from a microphone 6 to the codecs 33 and 39 of the data processing unit 3. For this, the audio processing unit 4 includes a band-pass filter 31 for band-pass-filtering the audio signal input from the microphone 6, and an analog-to-digital (A/D) converter 32 for converting the band-pass-filtered signal into a digital signal. The audio processing unit 4 further includes a digital-to-analog (D/A) converter 38 for converting a decoded audio signal provided from the data processing unit 3 into an analog signal, and a low-pass filter 37 for low-pass-filtering the converted analog audio signal and outputting the low-pass-filtered audio signal to a speaker 5.

The data processing unit 3 includes codecs 33 and 39 for compressing a transmitted signal, and a channel encoder 34 a modulator 35 for encoding and modulating the compressed data, and a demodulator 42 a channel decoder 41 for demodulating and decoding a received signal.

The GSM type mobile communication terminal to which the present invention is applied has diverse types of codecs. Accordingly, the data processing unit 3 includes a plurality of codecs 33 and 39, which compress signals digitalized in FS (Full-rate Speech), HS (Half-rate Speech), EFS (Enhanced Full-rate Speech), AFS (Adaptive-multi-rate FS) and AHS (Adaptive-multi-rate HS), and channel codecs 34 and 41. The channel codecs 34 and 41 can correct for transmission errors occurring on an air interface by adding a redundancy to the data. Here, it is preferable that the plurality of codecs 33 and 39 and channel codecs 34 and 41 are implemented by software.

The FS type codec completely compresses speech, the HS type codec enables multiple users to use it although the quality of speech is deteriorated, and the EFS type codec is an improved type of the FS type codec. The AFS type codec and the AHS type codec are multi-codecs, and their compression ratios are dynamically changed according to the channel environments. The AHS type codec is provided with a plurality of codecs having different compression ratios, and selectively heightens the compression ratio according to the channel environments.

Different types of codecs 33 and 39, which support the GSM type mobile communication system, are adopted in different countries. Thus, whenever the network 70 and the mobile communication terminal sets up a call, the control unit 7 of the mobile communication terminal transmits codec information and a function list belonging to itself to the network (which includes the BTSs, base station controller and mobile communication terminals). In response to this, the network selects a desired codec from among the plurality of codecs provided from the mobile communication terminal 21, and transmits to the mobile communication terminal a codec selection command corresponding to the selected codec. Then, the mobile communication terminal encodes and transmits the audio signal according to the corresponding codec, and decodes the audio signal transmitted from the network to recognize the corresponding codec, in accordance with the codec selection command transmitted from the network during the call set-up.

A process of transmitting an automatic answering message in the mobile communication terminal according to an embodiment of the present invention will be explained. It is assumed that the mobile communication terminal includes the automatic answering function, and since a method and process of setting the automatic answering function is well known, the detailed explanation thereof will be omitted.

FIG. 3 is a diagram illustrating the process of the mobile communication terminal when it transmits an automatic answering message according to the present invention.

As shown in FIG. 3, the transmission of the automatic answering message is performed through the band-pass filter 31 provided in the audio processing unit 4, the A/D converter 32, the encoders 33 and 39 of the codecs in the data processing unit 3 and the channel coders 34 and 41 for channel-coding the encoded data, the modulator 35 for modulating the channel-coded data, and the RF unit 1 for transmitting the modulated data.

The control unit 7 performs a predetermined automatic answering function when the call is received. The control unit 7 determines which coding type the input call signal is using according to the codec selection command provided from the network 70. Then, the control unit 7 restores the automatic answering message stored in the storage unit 10 to raw data by decoding the message through the decoder 39 of the codec that matches the coding type of the message. It is preferable that the automatic answering message pre-stored in the storage unit 10 is encoded in the HF type that has a small amount of data. The control unit 7 encodes the automatic answering message of the raw data through the encoder 33 of the codec that has the same coding type as the inputted call signal on the basis of the codec selection command. The control unit 7 channel-codes the encoded automatic answering message through the channel coder 34, modulates the channel-coded data through the modulator 35, and then transmits the modulated data through the RF unit 1.

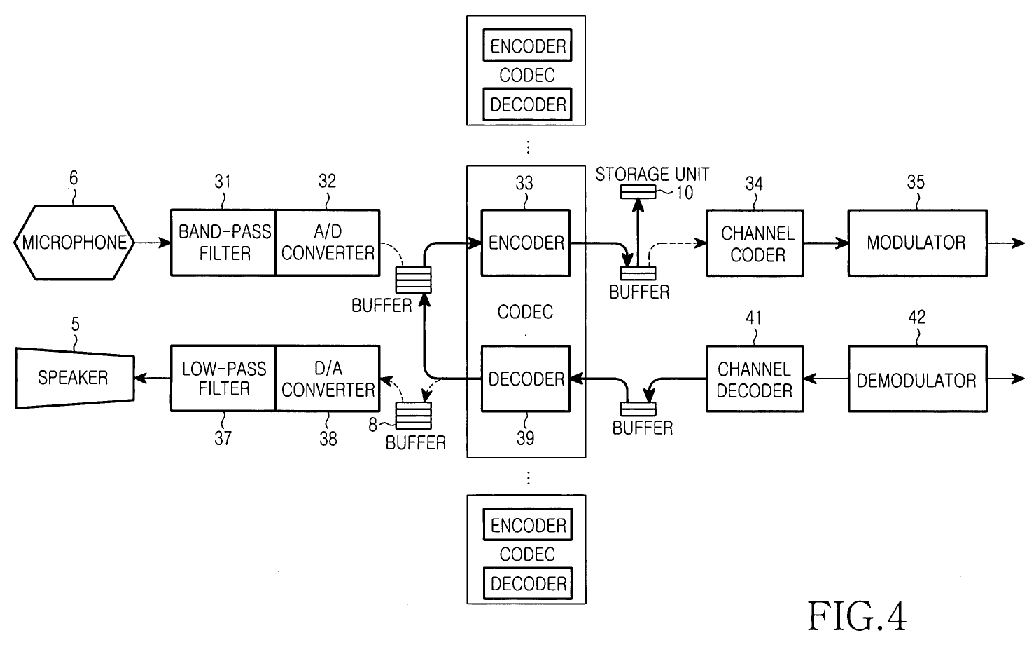

FIG. 4 is a diagram illustrating the process of the mobile communication terminal when it records an automatic answering message according to the present invention.

Referring to FIG. 4, if the calling terminal selects to record a message while the mobile communication terminal performs the automatic answering function, the control unit 7 receives and stores in the storage unit 10 a recorded message transmitted from the calling mobile communication terminal through the network 70 by performing a message recording algorithm.

At this time, the control unit 7 recognizes what type codec the recorded message was encoded with on the basis of the codec selection command provided from the network 70 in the call set-up process. In this case, it is preferable that the control unit 7 compresses the recording message transmitted from the calling mobile communication terminal using the HF type codec, and then stores the compressed message in the storage unit 10.

The controller 7 of the mobile communication terminal 11 receives the recorded message through the antenna ANT of the RF unit 1, and decodes the received message in the channel decoder 41. Then, the control unit 7 temporarily stores the channel-decoded recording message in a buffer 8. The control unit 7 restores the recording message temporarily stored in the buffer 8 to the raw data by decoding the recording message using the decoder of the codec recognized through the codec selection command transmitted from the network during the call set-up. Then, the control unit 7 decodes the audio data, i.e. the restored raw data, through the encoder of the HF type codec, and then stores the encoded audio data in the storage unit 10 through the buffer 8.

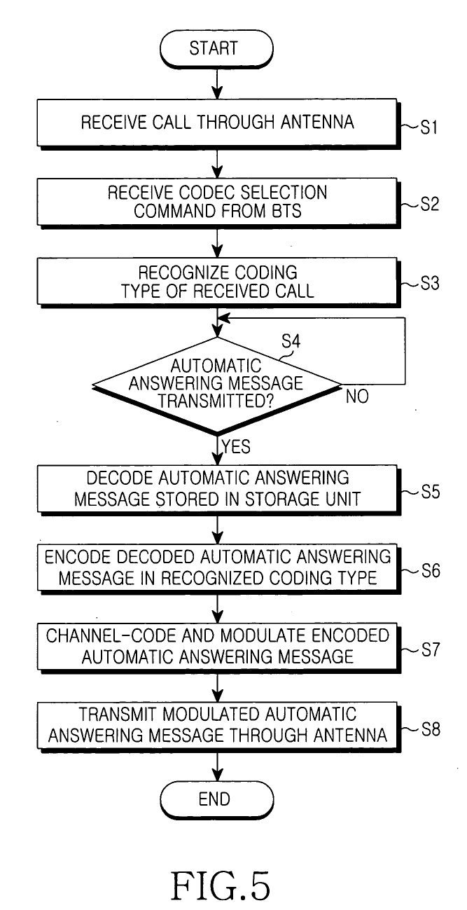

FIG. 5 is a flowchart illustrating the process of the mobile communication terminal when it transmits an automatic answering message according to the present invention.

As shown in FIG. 5, if the control unit 7 of the mobile communication terminal 11 receives a call signal from the opposite terminal through the network 70 at step S1, the mobile communication terminal transmits codec information and a function list to the network in order to set up the call. Then, if the network 70 selects a desired codec from among the codecs of the mobile communication terminal and transmits a codec selection command to the mobile communication terminal, the mobile communication terminal 11 receives the codec selection command transmitted from the network 70 at step S2. In the event that the mobile communication terminal 11 is set to the automatic answering function and is to transmit the automatic answering message, the control unit 7 determines which codec type the call is coded on the basis of the codec selection command transmitted from the network 70 at step S3. Then, the control unit 7 determines if the automatic answering function is set at step S4. If the automatic answering function is set, the control unit 7 decodes the automatic answering message stored in the storage unit 10 through the decoder of the HF type codec at step S5. The control unit 7 selects the corresponding encoder from among a plurality of encoders according to the coding type of the call signal, and encodes the automatic answering message that is the restored raw data through the selected encoder at step S6. Then, the control unit 7 encodes the encoded automatic answering message through the channel encoder 34, modulates the encoded message through the modulator 35 of the data processing unit 3 at step S7, and then transmits the modulated automatic answering message through the RF unit 1 at step S8.

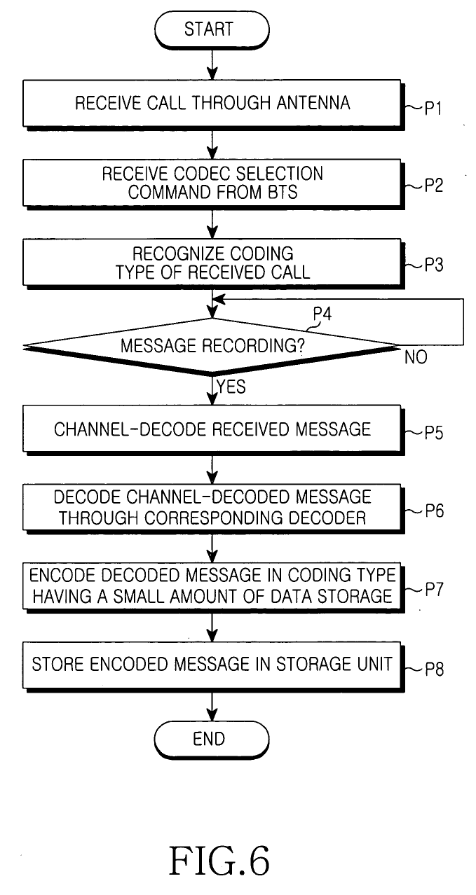

FIG. 6 is a flowchart illustrating the process of the mobile communication terminal when it records an automatic answering message according to the present invention. FIG. 6 shows the message recording process which is performed when the calling terminal selects the message recording while the mobile communication terminal performs the automatic answering function.

Referring to FIG. 6, if the mobile communication terminal receives a call through the antenna ANT of the RF unit 1 at step P1, it transmits codec information and a function list to the network 70 in order to set up the call. Then, if the network 70 selects a desired codec from among the codecs of the mobile communication terminal and transmits a codec selection command to the mobile communication terminal 11, the mobile communication terminal 11 receives the codec selection command transmitted from the network 70 at step P2. The control unit 7 determines the codec type of the call on the basis of the codec selection command transmitted from the network 70 at step P3. If the control unit 7 receives a selection signal which indicates that the calling terminal intends to record an audio through the network 70 at step P4, it performs an algorithm for recording the message. The control unit 7 channel-decodes the message received through the antenna ANT of the RF unit 1 through the channel decoder 41 of the data processing unit 3 at step P5, and temporarily stores the channel-decoded message in the buffer 8. Then, the control unit 7 decodes the message temporarily stored in the buffer 8 through the decoder of the corresponding codec on the basis of the codec selection command at step P6, and then encodes the message, i.e. the restored raw data, through the encoder of the HF type codec that has a high compression ratio to store the encoded message in the storage unit 10 at step P7.

As described above, the GSM type mobile communication terminal to which the present invention is applied has diverse types of codecs, and processes the call according to the codec that the network 70 has selected from among the diverse types of codecs. The GSM type mobile communication terminal transmits the automatic answering message which is encoded in a type of a codec that is desired by the network. The present invention aims at this point. The mobile communication terminal according to the present invention does not store the automatic answering message by codec types, but restores the pre-stored automatic answering message to raw data by decoding the pre-stored automatic answering message and again encodes the automatic answering message in a type of a codec determined by the network to transmit the encoded message to the network.

Meanwhile, in the case of storing the message transmitted from the calling mobile communication terminal, the mobile communication terminal restores the message provided from the network to raw data by decoding the message through the corresponding decoder, and then encodes the raw data through the HF type codec, which has a high compression ratio, to store the encoded data in the storage unit, so that the amount of data to be stored can be reduced.

While the invention has been shown and described with reference to certain preferred embodiments thereof, it will be understood by those skilled in the art that various changes in form and details may be made therein without departing from the spirit and scope of the invention as defined by the appended claims.

1. A method for automatically answering a mobile communication terminal which has an automatic answering function and is provided with a plurality of different audio codecs, the method comprising the steps of:
performing a call set-up when a call signal is received;
determining if the automatic answering function is set;
reading a pre-stored automatic answering message if the automatic answering function is set;
selecting an encoder of a codec which corresponds to a coding type of the call signal received during the call set-up; and
encoding the read automatic answering message through the encoder.

2. The method as claimed in claim 1, further comprising the step of receiving an audio codec selection command transmitted from a base transceiver subsystem during the call set-up, and recognizing the coding type of the call signal.

3. The method as claimed in claim 1, wherein the read automatic answering message is in an encoded state; and
wherein the automatic answering message is decoded through a decoder of the corresponding codec, and then encoded using the codec that corresponds to the coding type of the call signal.

4. The method as claimed in claim 1, further comprising the step of adding a redundancy bit to the encoded automatic answering message and channel-encoding the automatic answering message.

5. The method as claimed in claim 1, further comprising the steps of:
if an audio recording function of the automatic answering function is selected, decoding a received message by a decoder of the corresponding codec on the basis of an audio codec selection command;
encoding the decoded automatic answering message through a selected encoder of the codec having a high compression ratio among the plurality of audio codecs; and
storing the encoded message in a memory.

6. The method as claimed in claim 5, further comprising the step of removing a redundancy bit from the message received through the antenna, and channel-decoding the message while performing the audio recording function.

7. The method as claimed in claim 1, wherein the plurality of codecs include at least two codecs selected from among codecs of FS (Full-rate Speech), HS (Half-rate Speech), EFS (Enhanced Full-rate Speech), AFS (Adaptive-multi-rate FS) and AHS (Adaptive-multi-rate HS) types.

8. A mobile communication terminal which has an automatic answering function and is provided with a plurality of different audio codecs, comprising:
a storage unit in which an automatic answering message for the automatic answering function is pre-stored; and
a control unit for reading the automatic answering message stored in the storage unit, and encoding the read automatic answering message through an audio codec which corresponds to a coding type of a received call, if the automatic answering function is set when the call signal is received.

9. The mobile communication terminal as claimed in claim 8, wherein the control unit recognizes the coding type of the call signal on the basis of an audio codec selection command transmitted from a base transceiver subsystem when the call is set up.

10. The mobile communication terminal as claimed in claim 9, wherein when the automatic answering message is in an encoded state, the control unit reads and decodes the automatic answering message through a corresponding decoder, and then re-encodes the decoded message through the audio codec that corresponds to the coding type of the call signal.

11. The mobile communication terminal as claimed in claim 8, wherein if an audio recording function of the automatic answering function is selected, the control unit decodes a message received through the antenna through a decoder of the corresponding codec on the basis of an audio codec selection command, encodes the decoded automatic answering message through a selected encoder of the codec having a high compression ratio among the plurality of audio codecs, and stores the encoded message in the storage unit.

12. The mobile communication terminal as claimed in claim 8, wherein the plurality of codecs include at least two encodes selected from among codecs of FS (Full-rate Speech), HS (Half-rate Speech), EFS (Enhanced Full-rate Speech), AFS (Adaptive-multi-rate FS) and AHS (Adaptive-multi-rate HS) types.

13. The mobile communication terminal as claimed in claim 12, further comprising:
a channel coder for adding a redundancy bit to the encoded automatic answering message, and channel-coding the message; and
a channel decoder for removing the redundancy bit from the message received through the antenna, and channel-decoding the message during performing of the audio recording function.

14. A message storing method of a mobile communication terminal which has an automatic answering function and is provided with a plurality of different audio codecs, the method comprising the steps of:
receiving an audio codec selection command transmitted through a base transceiver subsystem when a call signal is received through an antenna;
performing the automatic answering function if the automatic answering function is set when the call signal is received;
reading a pre-stored automatic answering message if the automatic answering function is set;
decoding a received message by a decoder of the corresponding codec on the basis of the audio codec selection command if an audio recording is selected;
selecting an encoder of the codec which has a high compression ratio among the plurality of audio codecs, and encoding the decoded automatic answering message through the selected encoder of the codec; and
storing the encoded message.

15. The message storing method as claimed in claim 14, further comprising the step of receiving the audio codec selection command transmitted from a base transceiver subsystem when the call signal is set up, and recognizing the coding type of the call signal.

16. The message storing method as claimed in claim 14, wherein the plurality of codecs include at least two codecs selected from among codecs of FS (Full-rate Speech), HS (Half-rate Speech), EFS (Enhanced Full-rate Speech), AFS (Adaptive-multi-rate FS) and AHS (Adaptive-multi-rate HS) types.

17. The message storing method as claimed in claim 15, further comprising the step of removing a redundancy bit from the message received through the antenna, and channel-decoding the message.
